(19) United States
(12) Patent Application Publication
(10) Pub. No.: US 2014/0015403 A1
(43) Pub. Date: Jan. 16, 2014

(54) CERAMIC DISCHARGE METAL HALIDE (CDM) LAMP AND METHOD OFMANUFACTURE THEREOF

(71) Applicants: Ray Gage Gibson III, Bath, NY (US); Jay Palmer, Hammondsport, NY (US); John Alderman, Corning, NY (US); Gregory Allen Golding, Bath, NY (US)

(72) Inventors: Ray Gage Gibson III, Bath, NY (US); Jay Palmer, Hammondsport, NY (US); John Alderman, Corning, NY (US); Gregory Allen Golding, Bath, NY (US)

(73) Assignee: KONINKLIJKE PHILIPS N.V., EINDHOVEN (NL)

(21) Appl. No.: 14/007,336

(22) PCT Filed: Mar. 26, 2012
(86) PCT No.: PCT/IB2012/051423

§ 371 Date: Sep. 25, 2013

Related U.S. Application Data
(60) Provisional application No. 61/469,994, filed on Mar. 31, 2011.

(51) Int. Cl. H01J 61/34; H01J 9/24

(52) U.S. Cl. CPC H01J 61/34; H01J 9/247
USPC 313/573; 313/634; 313/577; 445/26

(57) ABSTRACT

A high-power ceramic discharge metal halide (CDM) lamp with a shroud-type containment assembly is disclosed. The lamp includes: a first shroud (138) with a first wall which forms a cylinder and which defines a first cavity; a second shroud (136) situated within the first cavity and which includes a second wall which forms a cylinder and which defines a second cavity situated within the first cavity of the first shroud; a first coil portion (140, 142) is situated about at least the one or the first and second shrouds (respectively); a ceramic arc tube (102) is situated in the second cavity and includes first and second openings, first and second leads (104, 106) with electrodes, and a lamp cavity (103) for containing a fill.

The present system relates to a ceramic discharge metal halide (CDM) lamp and, more particularly, to a high-power CDM lamp with an enhanced containment assembly and a method for manufacture thereof.

As the price of energy increases, inefficient bulbs are being replaced by energy saving retrofit bulbs which conserve power and provide enhanced illumination. Typical retrofit bulb types include quartz metal halide (QMH), ceramic discharge metal halide (CDM), and the like. Unfortunately, conventional CDM lamps are limited to certain applications and cannot typically be used as direct fit replacements for existing lighting systems such as probe start ballasts as will be discussed below. Further, as CDM lamps increase in power (rated wattage), it is difficult to contain the bulbs (e.g., as set forth by containment tests such as the over power American National Standards Institute (ANSI) containment test, etc.) in the event of failure without adversely affecting illumination output efficacy in lumens/Watt (Im/W).

With regard to high-power lamps, currently high wattage CDM lamps having a rating of more than about 700 watts are not commercially available. However, QMH lamps are available with ratings of 750, 1,000, and/or 1,500 watts. Further, QMH lamps having ratings of 875, 1,250, and 1,650, and 2,000 watts can be used to save energy but require unique ballasts. With regard to the 2,000 watt QMH lamps, these lamps are typically used in commercial areas such as sports arenas and the like. QMH lamps which are rated at 1000 watts or less typically have a life time rating of about 12,000 to 18,000 hours for vertical operation, and a shorter life time rating for horizontal operation. However, QMH lamps which have a rating that is greater than 1,000 watts typically have a life time rating of between 3,000 and 6,000 hours, and are primarily used for sports and stadium lighting. Most conventional lighting systems employ probe start ballasts which do not provide a high voltage pulse to start a lamp, accordingly, in these systems, lamps must ignite with peak open circuit voltage which may be as low as 622 volts as per ANSI standards. Further, although pulse start lamps exist, these are not typically interchangeable with probe start lamps (e.g., probe start QMH lamps) due to metal parts and insufficient clearances in the outer jacket where breakdown could occur. With respect to open fixtures, a class of lamps for open fixtures may meet an ANSI “O” designation and typically uses additional containment portion.

The present application discloses a lighting system which may be compatible with one or more lighting systems such as probe start, pulse start, enclosed, open rated lamps, etc. These lighting systems may include ballasts of various types such as ANSI ballast codes M47 and M141 for probe and pulse start systems, respectively, as well as lamp types MH1000, MP1000, and MS1000 quartz metal halide types (QMH). However, it is also envisioned that other lamps such as lamps having different power ratings may also be used with embodiments of the present system. For example a ˜1200 watt lamp operating on a QMH1500W ballast, or a ˜620W lamp operating on a QMH750W ballast may also be compatible with the present system. Further, because of enhanced characteristics such as lifespan, illumination, efficiency, cost, and/or multi-system compatibility, lamps in accordance with embodiments of the present system may be ideal for retrofitting conventional lamps.

In accordance with an aspect of the present system, there is disclosed a ceramic discharge metal halide (CDM) lamp. The lamp may include: a first shroud with a first wall which forms a cylinder and defines a first cavity; a second shroud situated within the first cavity and which includes a second wall which forms a cylinder and defines a second cavity situated within the first cavity of the first shroud; a first coil portion situated about at least one of the first and second shrouds; and/or a ceramic arc tube situated in the second cavity and which has first and second openings, and first and second leads each including an electrode, and which defines a lamp cavity for containing a fill. The apparatus may also include another coil portion situated between the first and second shrouds, wherein the first coil portion is situated about the first shroud. Moreover, the apparatus may include a frame having first and second side members which extend on opposite sides of the first and second shrouds. Further, the apparatus may include first and second shroud caps coupled to the side members of the frame and which may locate the first and second shrouds relative to each other. It is further envisioned that lamps in accordance with embodiments of the present system may further include a coil which may surround one or more parts, the frame and/or the first and/or second shrouds. The coils may have a number of turns which may be constant or variable in pitch. Moreover, the coils may include different pitch, number of turns, materials from each other. For example, a coil which is closer to a heat source such as an arc tube may be formed from a different material (e.g., molybdenum, etc.) which may have a higher resistance to heat than a material (e.g., nickel, etc.) coil which is further away from the heat source. Further, one or more of the coils may be coupled to the frame at one or more ends.

With respect to materials used for the coils, high temperatures such as temperatures above 600° C. which may be experienced even outside of the shrouds may cause some materials (e.g., nickel (Ni) or nickel plated wire) to experience “blackening.” Accordingly, materials resistant to blackening at these higher temperatures such as niobium (Nb), tungsten (W), zirconium (Zr), or others may be used to reduce or entirely prevent “blackening,” if desired. Moreover, with respect to areas within one or more of the shrouds, materials resistant to high temperatures such as molybdenum may be used to form the coils to reduce or entirely prevent “blackening.” However, other materials for the coils or combinations of materials are also envisioned.

Moreover, the fill may include a Penning mixture or a gas mixture of 99.5% Neon (Ne) and 0.5% Argon (Ar). Further, the fill may have a pressure less than or equal to 100 torr. The fill may further include a salt mix having Iodides selected from Sodium Iodide (NaI), Thallium Iodide (TII), Calcium (II) Iodide (CaI2), Cerium (III) Iodide (CeI3), and Manganese Iodide (MnI2). The percent weights of the Iodides of NaI, TII, CaI2, CeI3, and MnI2 range from between 0.8-3.8, 2.3-3.0, 82.6-93.8, 2.3-6.8, and 0.8-3.8, respectively.

In accordance with another aspect of the present system, there is disclosed a method for forming a ceramic discharge metal halide (CDM) lamp. The method may include acts such as: forming a first shroud comprising a first wall forming a cylinder defining a first cavity; forming a second shroud situated within the first cavity and comprising a second wall forming a cylinder defining a second cavity; situating a first coil portion around at least one of the first and second shrouds; and/or placing a ceramic arc tube in the second cavity, the ceramic arc tube may include first and second openings, and first and second leads with electrodes situated at an end thereof, and may define a lamp cavity for containing a fill. Further, the method may include an act of situating another coil portion between the first and second shrouds, wherein the first coil portion is situated about the first cylindrical shroud. Moreover, the method may include an act of forming a frame having first and second side members which extend on opposite sides of the first and second shrouds. Further, the method may include an act of attaching first and second shroud caps to the side members of the frame to position the first and second shrouds relative to each other.

The method may further include an act of filling the lamp cavity with the fill, wherein the fill comprises a Penning mixture or a gas mixture of 99.5% Neon (Ne) and 0.5% Argon (Ar). Moreover, the method may include an act of pressurizing the lamp cavity to have a pressure less than or equal to 100 torr. Further, the method may include an act of forming the fill to include a salt mix having Iodides selected from Sodium Iodide (NaI), Thallium Iodide (TiI), Calcium Iodide (CaI2), Cerium Iodide (CeI3), and Manganese Iodide (MnI2) into the cavity. Further, the method may include an act of forming the fill such that the percent weights of the Iodides of NaI, III, CaI2, CeI3, and MnI2 range from between 0.8-3.8, 2.3-3.0, 82.6-93.8, 2.3-6.8, and 0.8-3.8, respectively.

The invention is explained in further detail, and by way of example, with reference to the accompanying drawings wherein:

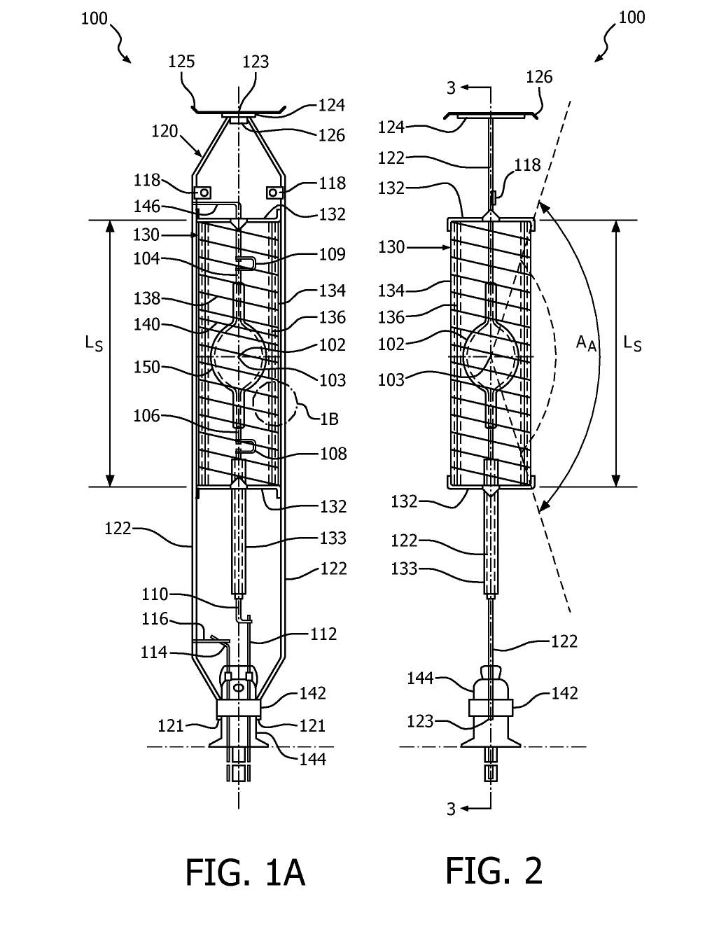

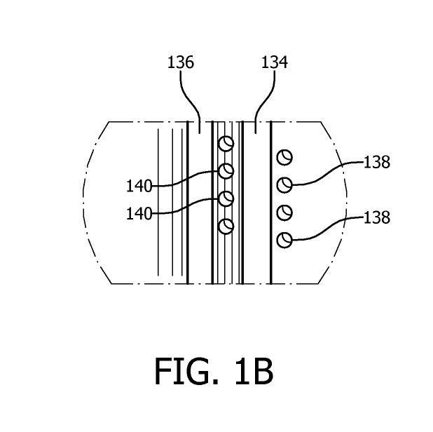

FIG. 1A is a front view of a portion of a lamp in accordance with embodiments of the present system;

FIG. 1B is a front view of a portion of the lamp shown in FIG. 1A in accordance with embodiments of the present system;

FIG. 2 is a side view of a portion of a lamp in accordance with embodiments of the present system;

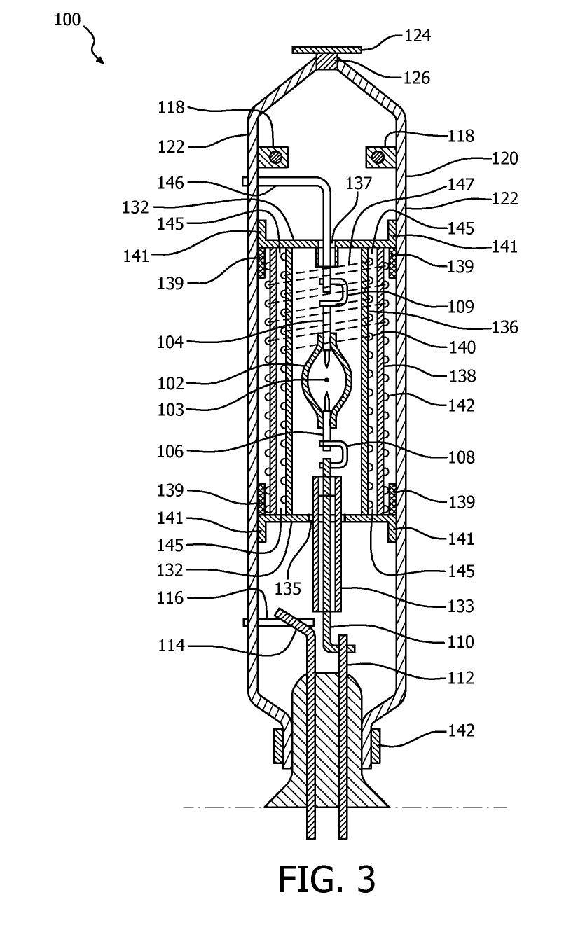

FIG. 3 is a cutaway view of the portion of the lamp taken along lines 3-3 of FIG. 2;

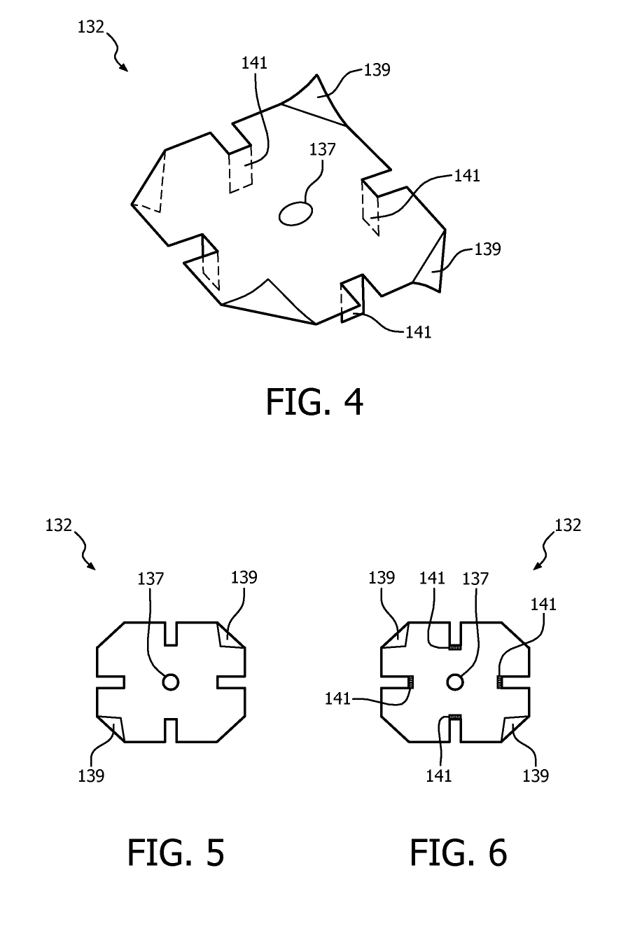

FIG. 4 is a perspective view of the shroud cap in accordance with embodiments of the present system;

FIG. 5 is a top view showing details of the shroud cap in accordance with embodiments of the present system;

FIG. 6 is a bottom view showing details of the shroud cap in accordance with embodiments of the present system;

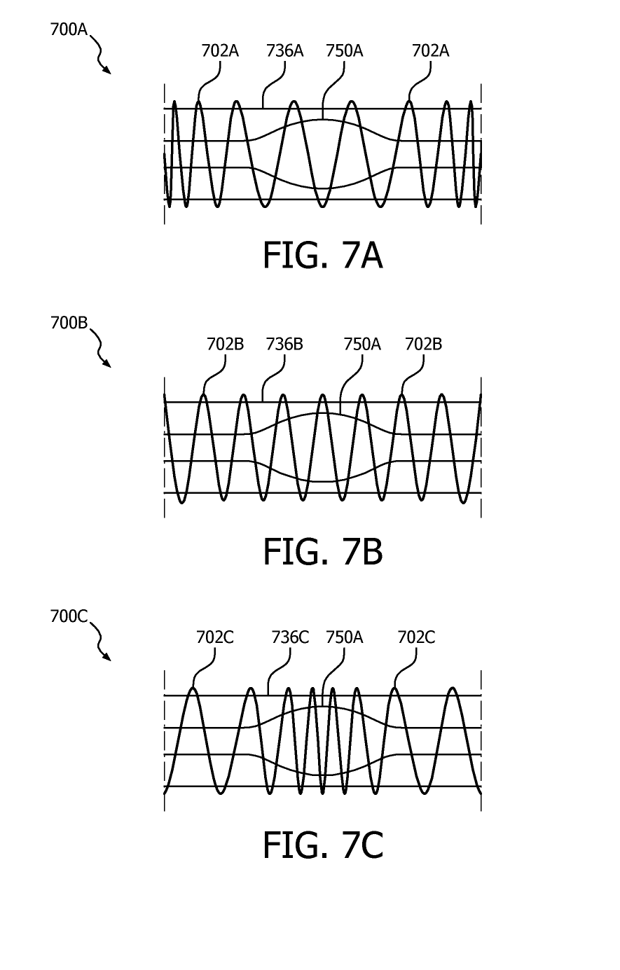

FIG. 7A is a side view of portion of a coil wrapped around a shroud in accordance with embodiments of the present system;

FIG. 7B is a side view of portion of a coil wrapped around a shroud in accordance with embodiments of the present system;

FIG. 7C is a side view of portion of a coil wrapped around a shroud in accordance with embodiments of the present system;

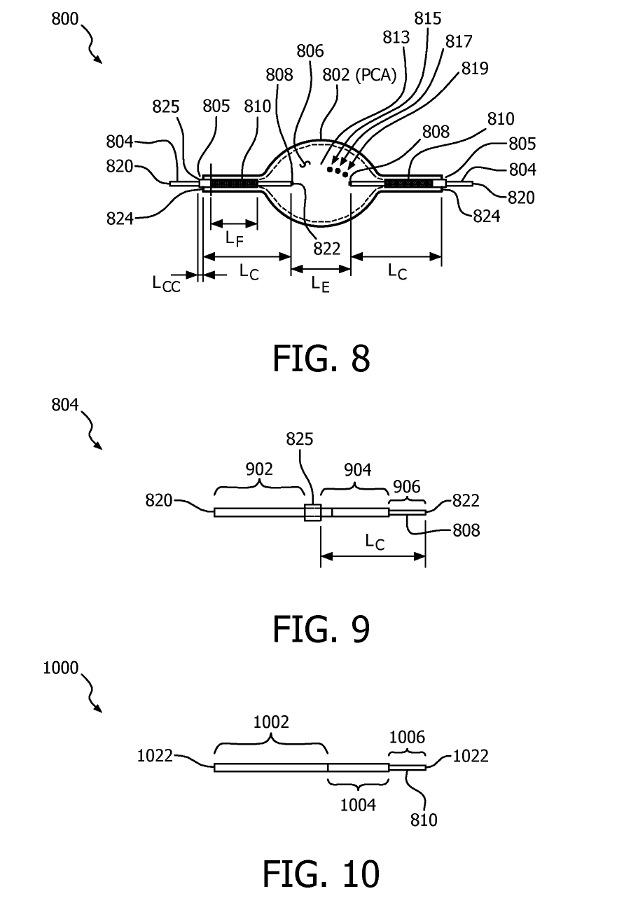

FIG. 8 is a cutaway view of a portion of an arc tube in accordance with embodiments of the present system;

FIG. 9 is a side view of a lead in accordance with embodiments of the present system;

FIG. 10 is a side view of a lead in accordance with embodiments of the present system;

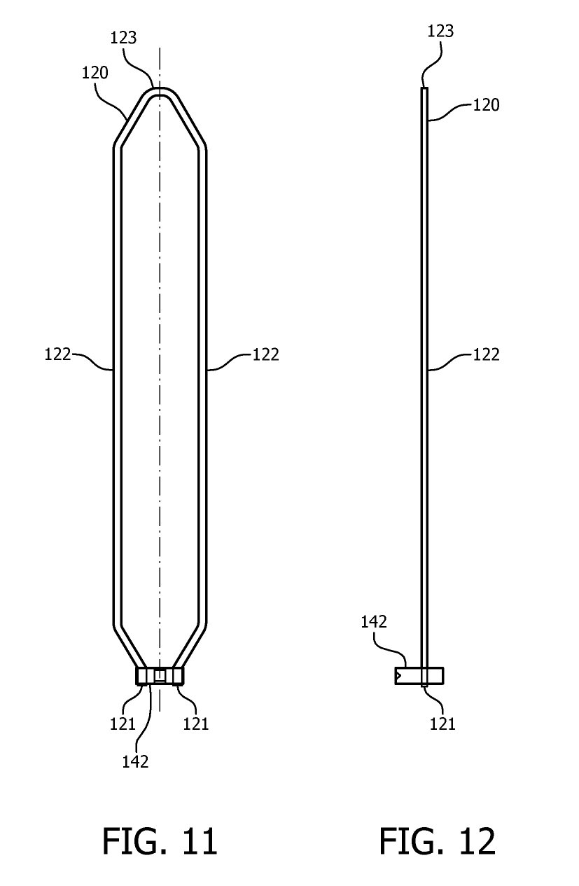

FIG. 11 is a front view of a portion of the frame in accordance with embodiments of the present system;

FIG. 12 is a side view of a portion of the frame in accordance with embodiments of the present system;

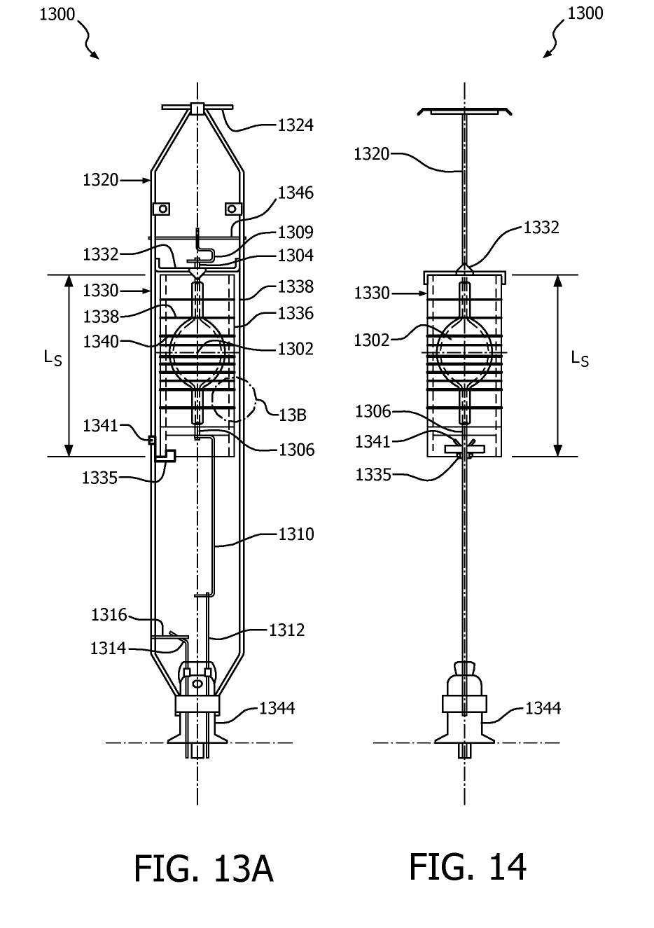

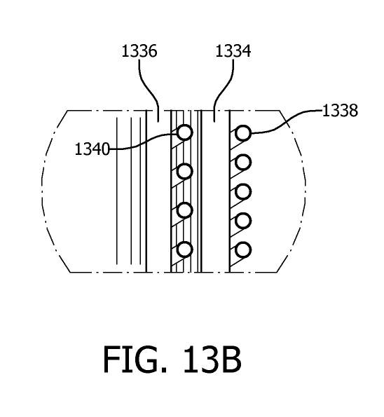

FIG. 13A is a front view of a portion of a lamp in accordance with embodiments of the present system;

FIG. 13B is a front view of a portion of the lamp shown in FIG. 13A in accordance with embodiments of the present system;

FIG. 14 is a side view of a portion of the lamp in accordance with embodiments of the present system;

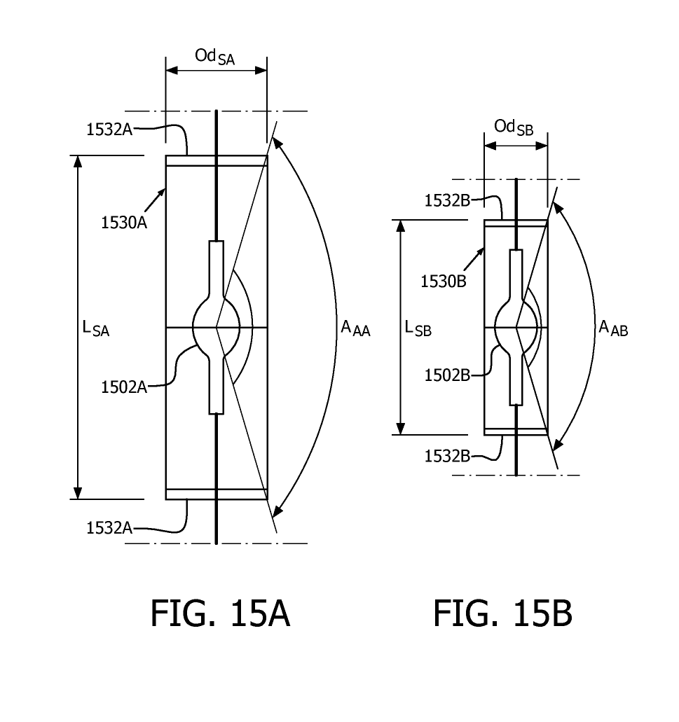

FIG. 15A is an illustration showing an acceptance angle in accordance with embodiments of the present system;

FIG. 15B is an illustration showing acceptance angles in accordance with embodiments of the present system;

FIG. 16 is a side view of a lamp in accordance with embodiments of the present system;

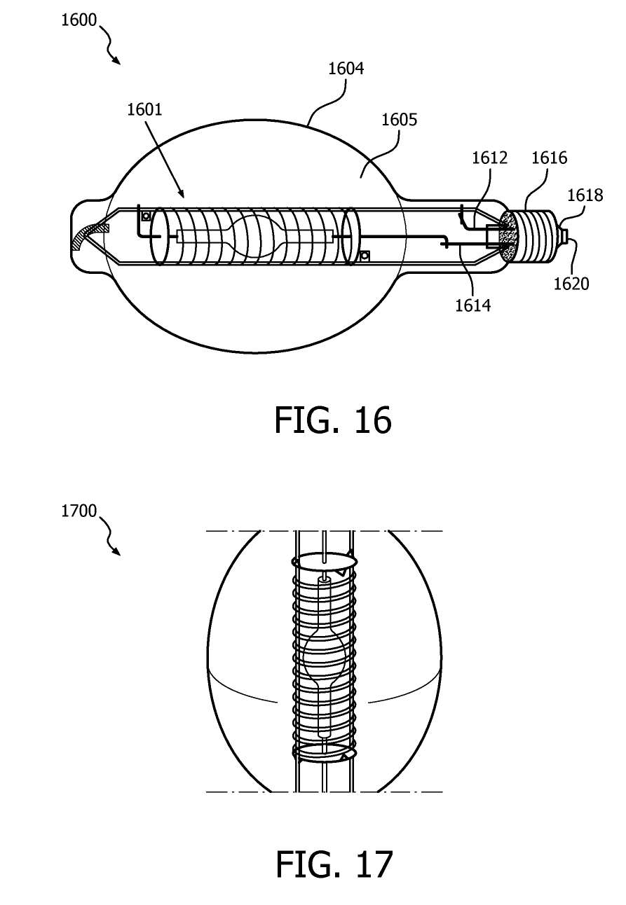

FIG. 17 is a perspective view of a lamp 1700 in accordance with embodiments of the present system;

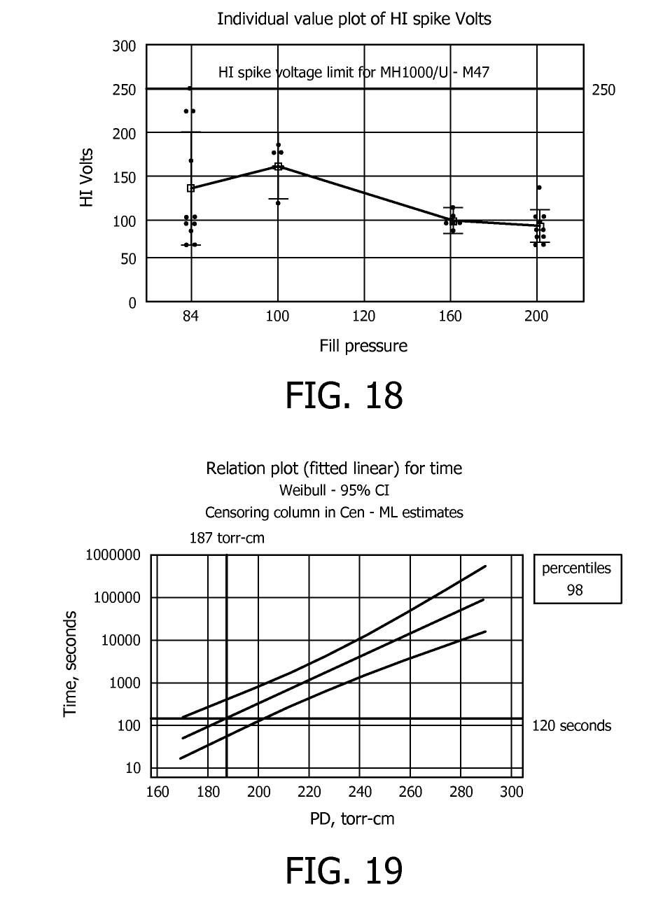

FIG. 18 is a graph which illustrates hydrogen iodide (HI) voltage spikes vs. Neon/Argon (Ne/Ar) fill pressure for a lamp in accordance with embodiments of the present system;

FIG. 19 is a graph which illustrates starting time vs. electrode distance (D)×fill pressure (P) (P×D) for a lamp in accordance with embodiments of the present system;

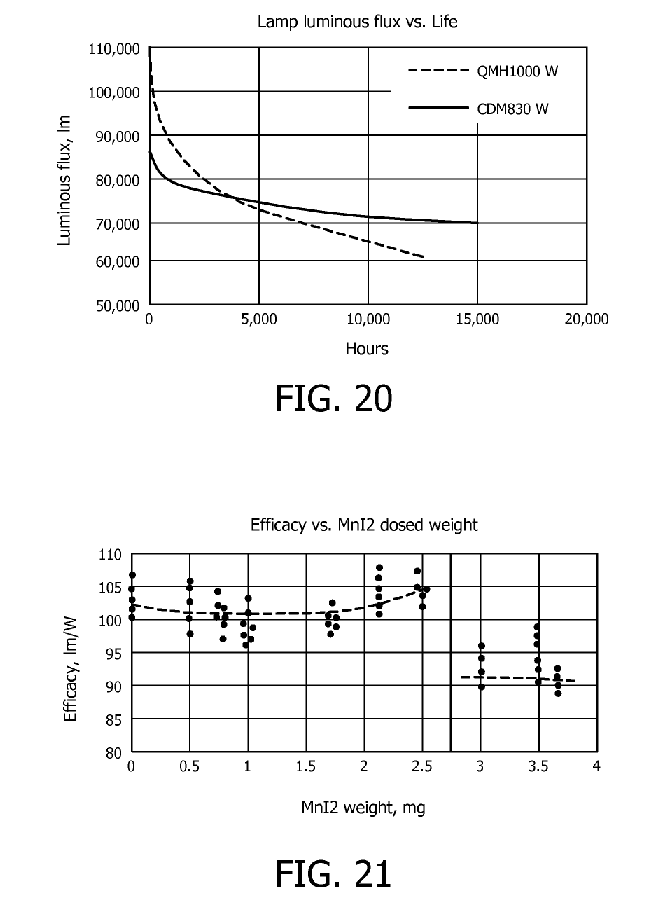

FIG. 20 which is a graph which illustrates luminous flux vs. hours for a CDM lamp in accordance with embodiments of the present system;

FIG. 21 is a graph which illustrates luminous efficacy vs. manganese iodide (MnI2) dose for a fill of an arc tube of a lamp in accordance with embodiments of the present system;

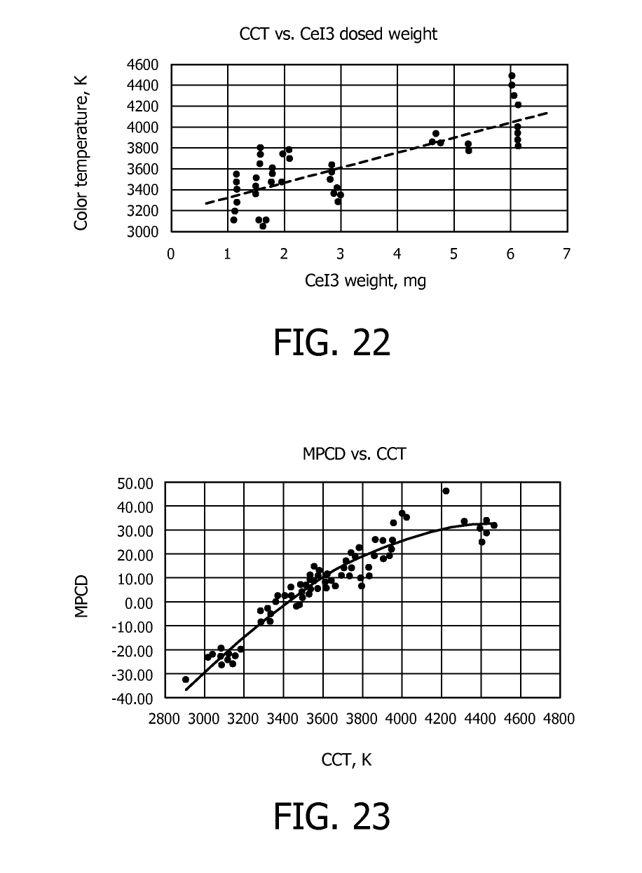

FIG. 22 is a graph which illustrates color temperature (CCT) vs. cerium iodide (CeI3)dose for a fill of an arc tube of a lamp in accordance with embodiments of the present system;

FIG. 23 is a graph which illustrates mean perceptable color difference (MPCD) vs. CCT for experimental high wattage CDM for lamps in accordance with embodiments of the present system;

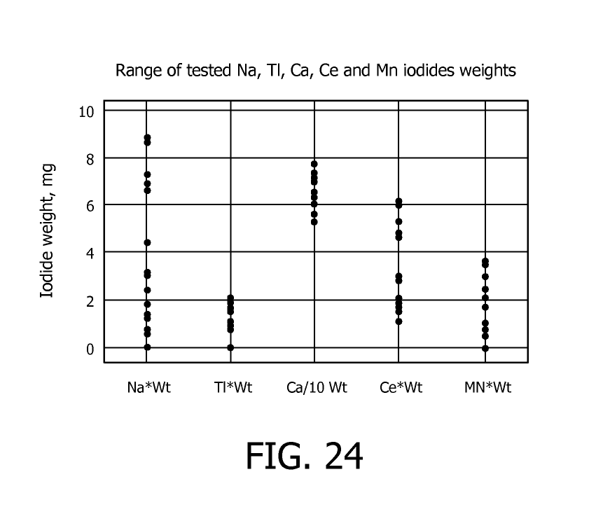

FIG. 24 is a graph illustrating salt ranges of iodide salt doses for enhanced results for lamps in accordance with embodiments of the present system; and

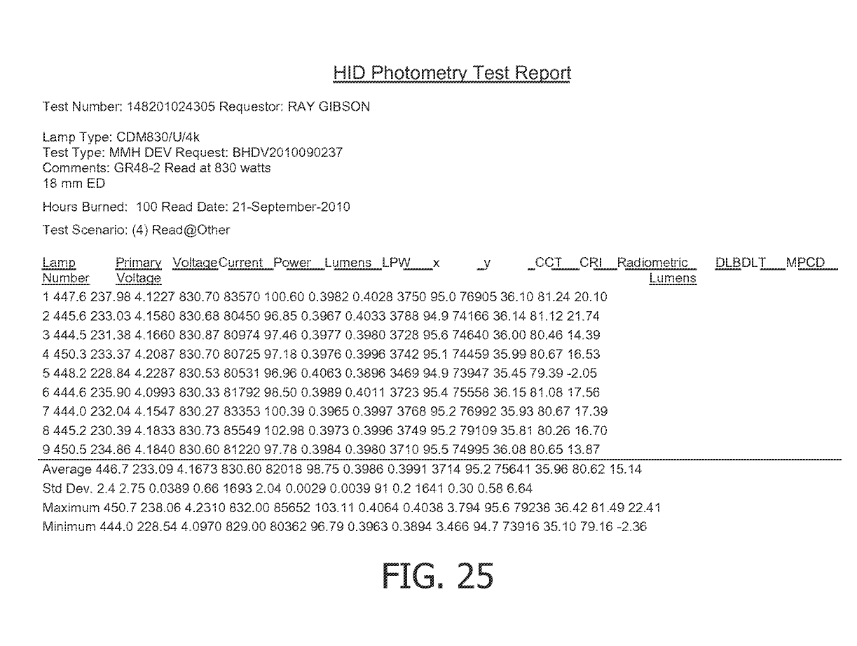

FIG. 25 is a table illustrating photometry values for these 9 lamps whose experimental test results are illustrated in Table 3 below in accordance with embodiments of the present system.

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well known devices, circuits, tools, techniques and methods are omitted so as not to obscure the description of the present system. It should be expressly understood that the drawings are included for illustrative purposes and do not represent the scope of the present system. In the accompanying drawings, like reference numbers in different drawings may designate similar elements.

For purposes of simplifying a description of the present system, the terms “operatively coupled”, “coupled” and formatives thereof as utilized herein refer to a connection between devices and/or portions thereof that enables operation in accordance with the present system.

FIGS. 1, 2 and 3 will be discussed to illustrate embodiments of the present system. FIGS. 1A, 1B are front views of a portion of a lamp 100 in accordance with embodiments of the present system. FIG. 2 is a side view of a portion of a lamp in accordance with embodiments of the present system. FIG. 3 is a cutaway view of the portion of the lamp taken along lines 3-3 of FIG. 2.

The lamp 100 may include a frame 120 which may support an arc tube 102 and a shroud portion 130. The frame 120 may include one or more extension portions 122 (e.g., side members) and may extend between proximal and distal ends 121 and 123, respectively, of the frame 120. For the sake of clarity, it will be assumed that the frame 120 is symmetric and the extension portions 122 mirror each other. However, it is also envisioned that the frame may be asymmetric and, for example, include a single extension portion or extension portions which are not mirror images of each other. At the proximal end 121, the frame 120 may be secured to a stem portion 144 using any suitable method such as a frame clip 142 which may wrap around both of the stem portion 144 and at least one of the extension portions 122 for example providing a friction fit for respective portions. The stem portion 144 may be mounted to any suitable mounting portion dependent upon a type of mount desired. The frame 120 may include a distal support portion 125 at the distal end 123. The distal support portion 125 may be supported by portions of an outer bulb portion and preferably holds the frame 120 in a desired position relative to the outer bulb portion during use. Accordingly, the distal support portion 125 may include a mount portion 126 and a disc 124 such as a mica disc. The mount portion 126 may include a biasing member which may provide a frictional force against an outer bulb to secure the fame portion 120 relative to the outer bulb. The disk 124 may be formed from a suitable material such as mica and may be shaped and sized such that it may prevent parts of a failed lamp from becoming lodged in a dome of the lamp.

Getters such as getters 118 may be provided to control an environment within a cavity of the outer bulb portion (for example, by absorbing oxygen, moisture, etc.) and may be attached to, for example, at least one extension portion 122, other portions of the frame 120 or otherwise be applied to control the environment. As getters are well known in the art, a further description thereof will not be provided for the sake of clarity.

First and second stem leads 112 and 114, respectively, may be formed from a suitable conductive material and may extend through the stem portion 144 such that the stem portion 144 may form a seal about the first and second stem leads 112 and 114, respectively. The second stem lead 114 may be coupled to the extension portion 122 of the frame 120 via a frame connector 116. Accordingly, the frame connector 116 may be attached to the frame 120 and/or to the second stem lead 114 using any suitable method such as welding, friction fitting (e.g., crimping, etc.), etc. However, it is also envisioned that the second stem lead 114 may be directly coupled to the frame 120. The first stem lead 112 may be coupled to a base lead 110 using any suitable method such as welding, friction fitting, etc. The frame connector 116 may be formed from a coiled spring having a plurality of turns and may be flexible, if desired.

The shroud assembly 130 may include one or more portions such as first and second shroud portions 134 and 136, respectively, and first and second coils 138 and 140, respectively, and shroud caps 132. The first and/or second shroud potions 134 and 136, respectively, may comprise a cylindrical tubes formed from a suitable material such as glass (e.g., quartz, etc.) having a wall thickness (T_{wall}) of, for example, 2 mm. In the present embodiment, there may be a 1 mm separation between adjacent walls of the first and second shroud portions 134 and 136, respectively, to provide space for the coil 140 to be placed around the outer periphery of the second shroud 136. However, other thicknesses are also envisioned. For example, the thickness of the first and/or second shroud potions 134 and 136, respectively, may be the same as or different from each other. Thus, the first shroud portion 138 may define a cavity 145 and the second shroud portion 138 may define a cavity 147. The second shroud portion 136 may be situated within the cavity 145 of the first shroud portion 134 such that the first and second shroud portions 134 and 136, respectively, are concentrically located relative to each other. However, it is also envisioned that the first and second shroud portions 134 and 136, respectively, may be other than concentrically located relative to each other. Accordingly, for example, the first and second shroud portions 134 and 138, respectively, may be offset relative to their longitudinal axes and/or relative to their other axes. The first and second shroud portions 134 and 136, respectively, may have respective lengths Ls1 and Ls2 which may be equal to each other and, for the sake of clarity, will be commonly referred to as shroud length Ls. However, it is also envisioned that the lengths Ls1 and Ls2 may be different from each other. The shroud assembly 130 may further include one or more wire coils such as the first and second coils 138 and 140, respectively, each of which may be formed from a suitable material such as wire (e.g., a molybdenum(Mo or Moly) wire, a nickel-plated stainless steel wire, etc.) which forms a spiral having a number of turns (Nt). The Nt of the first and second wire coils 138 and 140 may be the same as or different from each other. The first coil 138 may be situated about the first shroud portion 134 and the second coil 140 may be situated about the second shroud portion 136 such that it is between the first and second shroud portions 134 and 136, respectively, and within the cavity 145 of the first shroud portion 134. It is further envisioned that the first and second coils may be formed from a material other than a wire such a planar, stamped, and/or etched, metal having openings. The coils are preferably formed from a conductive material. However, it is also envisioned that a high-temperature fiber such as a glass fiber may also be used in accordance embodiments of the present system.

The shroud caps 132 may be attached to one or more of the extension portions 122 of the frame 120 using any suitable method such as tab (e.g., which may provide a friction fit, etc.), a weld, etc., such that the first and second shroud portions 134 and 136, respectively, and/or first and second coils 138 and 140, are situated there between.

The arc tube 102 may be located within the cavity 147 of the second shroud portion 136 (which is located in the cavity 145 of the first shroud portion 134) and may include a tube 150 and first and second leads 104 and 106, respectively. The tube 150 may define a cavity having first and second openings through which respective ones of the first and second leads pass there through and are sealed using any suitable method such as a frit ring, etc. The second lead 106 may be coupled to the base lead 110 via a connector 108 and the first lead 104 may be coupled to the frame 120 via a connector 109 and/or a distal lead 146.

The distal lead 146 may pass through an opening in the corresponding shroud cap 132 and the base lead 110 may pass through an opening within the corresponding shroud cap 132 and may be insulated there from by an insulator 133 which may be formed from a suitable material such as quartz glass which may form a cylindrical tube or the like. It is preferred that portions at opposite potentials have sufficient clearance such as, for example, and, in some embodiments 9 mm of clearance may be sufficient although other clearances are envisioned in accordance with embodiments of the present system.

FIG. 2 is a side view of a portion of a lamp 100 in accordance with embodiments of the present system illustrating an acceptance angle (AA) that may be defined as an angle which extends from a center 103 (or center of an area or volume of illumination) of the arc tube 102 and whose sides intersect an outer periphery or edge of the shroud assembly 130. Accordingly, the longer Ls is, the larger the AA is; and conversely, the smaller Ls is, the smaller AA is. Acceptance angles are discussed below with reference to a discussion of FIGS. 15A and 15B.

As illustratively shown in FIG. 3, the shroud caps 132 may be attached to one or more of the extension portions 122 of the frame 120 using any suitable method such as a mounting tab 141 which may frictionally engage an adjacent extension portion 122 of the frame assembly 120. The first and second shroud portions 134 and 136, respectively, and/or the first and second coils 138 and 140, respectively, held in location by tabs 139 of the corresponding shroud caps 132. Further, with respect to the shroud caps 139 for the sake of clarity, it will be assumed that they are the same. However, it is also envisioned that the shroud caps may be different from each other.

FIG. 4 is a perspective view of the shroud cap 132 in accordance with embodiments of the present system. The shroud cap 132 may be formed from a suitable material such as stainless steel, or nickel plated steel, etc., and may be stamped to form the opening 137, tabs 139 and/or mounting tabs 141. FIG. 5 is a top view showing details of the shroud cap 132 in accordance with embodiments of the present system. FIG. 6 is a bottom view showing details of the shroud cap 132 in accordance with embodiments of the present system.

FIG. 7A is a side view of portion of a coil 702A wrapped around a shroud 736A in accordance with embodiments of the present system. An arc tube 750A is situated within the shroud 736A. The coil 702A may have a variable pitch which may increase towards a center portion of the shroud 736A.

FIG. 7B is a side view of portion of a coil 702B wrapped around a shroud 736B in accordance with embodiments of the present system. An arc tube 750B is situated within the shroud 736B. The coil 702B may have a constant pitch.

FIG. 7C is a side view of portion of a coil 702C wrapped around a shroud 736C in accordance with embodiments of the present system. An arc tube 750C is situated within the shroud 736C. The coil 702C may have a variable pitch which may decrease towards a center portion of the shroud 736C. Accordingly, a spacing or pitch between adjacent turns of the coil(s) may be increased towards the center portion of the shroud. During containment tests, when the lamps were operated under test conditions to shatter one or more of the shrouds, it was found that shrouds shattered into smaller pieces in the center portion of the shroud which area situated closest to a center portion of an arc tube and into larger pieces at the end portions of the shroud which are further away from the center portion of the arc tube. Thus, to contain smaller shattered pieces of a shattered shroud which are expected to be located about the center area of the shroud, a smaller coil pitch may be used in portion of the coil which surrounds the center area of the shroud. Similarly, to contain larger pieces of a shattered shroud which would be expected to be located at the end areas about the center area of the shroud, a larger coil pitch may be used in these portions of the coil.

Further, with respect to diameter of a shroud, the size of the pieces of a shattered shroud increase as the distance from center of the shroud increases. Conversely, the pieces of shattered shrouds decrease in size from outside the shroud to the inside shroud, and from the ends towards the center of the shrouds. Thus, in certain embodiments, it is envisioned that the pitch of coils may be increased as the diameter of a shroud about which the coil is located increases (with the arc tube remaining constant in size).

Accordingly, it is envisioned that in some embodiments, pitch or spacing between coils may be adjusted for containment purposes. For example, in accordance with embodiments of the present system, a shroud assembly may include inner and outer shrouds and an inner coil situated about the inner shroud and an outer coil situated about the outer shroud. The inner coil may have N turns and the outer coil may have M turns, thus, forming a shroud having a (N+M) configuration. For example, if the inner and outer coils have 5 turns each, the shroud may have a (5+5) configuration. Thus, assuming that shrouds may shatter into different sized pieces in different portions of the shroud, the pitch or spacing, of the turns especially in portions of a coil which are situated around portions of a shroud which is around the center of the arc tube may be increased to enhance shatter protection. For example, in accordance with embodiments of the present system, a shroud may have a (5+5) configuration with a pitch of about 30 mm between turns, a (10+10) configuration with a pitch of about 15 mm between turns, and a (15+15) configuration with a pitch of about 10 mm between turns. The pitch may remain constant or may vary. Further, additional turns may be provide to account for sag of the coils which may occur during use. However, other number of turns and/or pitch are also envisioned.

Further, with respect to the number of turns Nc, the turns per unit length such as turns per inch or pitch may be constant and/or be non-constant (e.g., variable). For example, with respect to constant turns, there may be 6 turns per inch and with respect to non-constant turns per inch, there may be 6 turns per inch for the first half inch and then there may be 12 turns per inch for the next half inch, etc.

FIG. 8 is a cutaway view of a portion of an arc tube 800 in accordance with embodiments of the present system. The arc tube 800 may be similar to the arc tube 102 and may include a body portion 802, and leads 804. The body portion 802 may define a cavity 806 having openings 805. The leads 804 may extend through a corresponding opening 805 of the openings 805 in the body portion 802. The cavity 806 may include a fill 813 which may include one or more of mercury 815, salts 817 (e.g., a salt mix), and a chemical 819. The salts 817 may include any suitable salts as are described herein and may include, for example, iodides of sodium (Na), thallium (TI), calcium (Ca), cerium (Ce), and manganese (Mn), although other materials such as dysprosium (Dy), Thulium (Tm), holmium (Ho), lithium (Li), and In or others may be suitably applied. For exampe, it is envisioned that other suitable salts may include iodides of zirconium (Zr), praseodymium (Pr), scandium (Sc), etc. Each of the leads 804 may have proximal and distal ends 820 and 822, respectively, and an electrode 808 at the distal end 822. Further, one or more of the leads 804 may include a crimp 825 situated between the proximal and distal ends 820 and 822, respectively. The crimp may be provided to set electrode spacing with respect to the body. A frit 810 may be situated within walls of the openings 805 and a corresponding lead 804 so as to seal the cavity 806. The distal ends 822 may be situated apart from each other by a distance Le of about 16 to 18 mm and may be apart from the crimp 825 by a crimp distance Lc which may be about 30.5 mm +/−0.1 mm although other dimensions are also envisioned. The cermet 810 may have a length Lf which may be about 16 mm +/−0.1 mm, although other dimensions are also envisioned. Further, the crimp 825 may have a length Lcc which may be about 1.3 mm +/−0.1 mm, although other dimensions are also envisioned.

FIG. 9 is a side view of the lead 804 in accordance with embodiments of the present system. The lead 804 may include portions 902, 904, and 906 which may correspond with a Niobium (Nb) section, a cermet section, and an electrode section, respectively. The crimp 825 may have an outside diameter which is larger than an inside diameter of an arc tube opening (e.g., see, openings 805) through which the lead 804 extends. The lead may join the Nb and the cermet sections 902 and 904, respectively, to each other.

FIG. 10 is a side view of a lead 1000 in accordance with embodiments of the present system. The lead may include portions 1002, 1004, and 1006 which may correspond with an Nb section, a cermet section, and an electrode section, respectively.

FIG. 11 is a front view of a portion of the frame 120 in accordance with embodiments of the present system. The frame clip 142 may include a full or partial loop and may be attached to the frame 120 using any suitable method such as welding, friction fitting, etc. FIG. 12 is a side view of an illustrative portion of the frame 120 in accordance with embodiments of the present system.

FIG. 13A is a front view of a portion of a lamp 1300 in accordance with embodiments of the present system. FIG. 13B is a front view of a portion of the lamp shown in FIG. 13A in accordance with embodiments of the present system.

Referring to FIG. 13A, the lamp 1300 is essentially similar to the lamp 100. However, the lamp 1300 may have a different shroud portion 1330 which may include shroud caps 1332 and 1335 which are different from each other and may be connected to a frame 1320 and support one or more shrouds such as first and second shrouds 1334 and 1336, respectively. A first coil 1338 may be situated about the first shroud 1334 and a second coil 1340 may be situated about the second shroud 1336 as is illustrated in a detailed view shown in FIG. 13B which shows of a portion of the first and second shrouds 1334 and 1336, respectively, and the first and second coils, 1338 and 1340, respectively, in accordance with an embodiment of the present system. Referring back to FIG. 13A, an arc tube 1302 may include first and second leads 1304 and 1306, respectively. The first lead 1304 may be coupled to the frame 1320 via a connector 1309 and a cross brace 1346; and the second lead 1306 may be coupled to a first stem lead 1312 via a connector 1310. The connector 1310 may pass through an opening in the shroud cap 1335. The shroud cap 1335 may include a tab 1341 which may frictionally engage the frame 1320 so as to hold the shroud cap 1335 in position relative to the frame 1320 and may be welded to the frame 1320. The shroud cap 1335 may be a partial shroud cap and may hold a portion of the first and second shrouds 1334 and 1336, respectively. The frame 1320 may be coupled to a second stem lead 1314 via a frame connector 1314 which may pass through a stem 1344.

FIG. 14 is a side view of a portion of the lamp 1300 in accordance with embodiments of the present system.

FIG. 15A and FIG. 15B are illustrations showing acceptance angles in accordance with embodiments of the present system. With reference to FIG. 15A, an arc tube 1502A is mounted within a cavity of a shroud assembly 1530A having a length Lsa and held in position by opposed shroud caps 1532A which have an outer periphery defining a diameter Odsa. An acceptance angle AAA is shown with a vertex at about a midpoint of the arc tube 1502A and intersecting with the outer periphery of the shroud 1532A. With reference to FIG. 15B, an arc tube 1502B is mounted within a cavity of a shroud assembly 1530B having a length Lsb and held in position by opposed shroud caps 1532B which have an outer periphery defining a diameter Odsb. An acceptance angle AAB is shown with a vertex at about a midpoint of the arc tube 1502B and intersecting with the outer periphery of the shroud 1532B. For the sake of clarity, it will be assumed that the Odsa and Odsb are the same. Accordingly, it is seen that the acceptance angles AAx are related to the distance between the corresponding opposed shrouds 1532x which should be substantially equal to the length of the shrouds 1320x Lsx. Accordingly, with reference to FIGS. 15A and 15B, the longer Lsx is, the larger the AAx is; and conversely, the smaller Lsx is, the smaller AAx is. It is preferred that the acceptance angle be as large as possible to enhance illumination efficiency.

The shroud length may be selected to enhance (e.g., maximize) the acceptance angle and therefore increase illumination efficiency without being excessively large which may require extra material and increase weight as well as cost. For example, to control acceptance angles larger diameter shrouds may need to be longer to have the same or a similar acceptance angle as a smaller diameter shroud may have. Accordingly, it may be desirable to decrease (e.g., minimize) the shroud diameter so that length may be decreased which may conserve material and reduce cost.

In accordance with embodiments of the present system (e.g., an 830W lamp), an arc tube outer diameter (OD) may be 28 mm, and inner shroud may have an inside diameter (ID) of about 34 mm, thus providing a gap of about 3 mm surrounding the arc tube. This gap should be sufficient to prevent over-heating of the arc tube and to allow for variations with mounting, and misalignments which may occur during shipping, handling, etc. The shroud thickness may be dependent upon containment needs, and, in the present embodiment both shrouds (e.g., the first and the second shrouds) may be about 2 mm thick (e.g., have a wall thickness), and a spacing between the shrouds may be about 1 mm all around to leave space for the inner containment coil and variations with the shroud dimensions. The first (e.g., outer) shroud may have an IDof about 40 mm and an OD of about 44 mm. Further, with regard to length, the first and/or second shrouds may have a length of about 150 mm. However, other dimensions are also envisioned. For example, smaller diameter arc tubes may have shorter lengths and/or smaller diameters, and larger diameter arc tubes may have larger diameters and longer length shrouds, etc.

FIG. 16 is a side view of a lamp 1600 in accordance with embodiments of the present system and FIG. 17 is a perspective view of a lamp 1700 in accordance with embodiments of the present system. For example, the lamp 1600 may include an outer bulb 1604 having a cavity 1605 in which a lamp assembly 1601 is contained. The cavity 1605 may be sealed by a base 1606 suitable for mounting in a desired mounting socket such as an E or O type mounting socket. The base 1606 may include a contact 1610 which is electrically coupled to one of first or second stem leads 1612 and 1614, respectively. An insulator 1608 and/or a sealer such as a Vitrite insulator may insulate the contact 1610 from the base 1606. Accordingly, for example, the lamp 1600 may provide an 830W energy saving retrofit lamp for conventional QMH 1000W systems.

Containment

It was found that to pass containment tests such as the ANSI containment test for open fixture rated lamps, certain mounting procedures may be desirable. This becomes particularly true as the rated power of lamps increases. Accordingly, a comparison of available energies during lamp operation (e.g., operating energy (EO)) and during the containment test for several open fixture lamps is provided herein in accordance with embodiments of the present system to provide an understanding of acceptable containment methods. With regard to energy used during operation of a lamp, this may be referred to as operating energy (OE) and may be calculated from the product P×V where P is the operating pressure, and V is the arc tube volume. The operating pressure (P) may also be estimated from the Hg dose (e.g., in mg) divided by an arc tube volume in cm³ of the arc tube so that the arc tube volumes cancel. Scaling to units of Joules, the OE of a lamp may be simply (and approximately) related to the mercury dose as defined in Equation 1 below.

Operating Energy (J)=0.1×Hg(mg) Eq. (1)

Table 1 illustrates operating energy and voltage for several CDM lamp types based on Equation 1, and containment methods which may be set in accordance with the determined operating energy for the lamp type in accordance with embodiments of the present system/lamps. For example, certain high operating energy (e.g., high wattage) lamps have an operating energy which may be between 5 and 60 times greater than the operating energy of lower voltage and wattage lamps. Accordingly, high operating energy lamps may include more containment “elements” than lamps with having a lower operating energy (c.f., x-CDM400HPSRW and x-CDM 830W) in Table 1 which illustrates nominal voltage and operating energy for hypothetical lamps x.

TABLE 1

| | | Operating | |
|---|---|---|---|
| | Nominal | Energy | Containment Method |
| Lamp | Voltage | (J) | (elements) |
| x-CDM400HPSRW | 100 | 0.4 | 6 Turn Moly Coil |
| x-CDM400/PS | 150 | 1.2 | 6 Turn Moly Coil |
| x-CDM 315 Elite | 100 | 2.8 | Quartz Outer Shroud |
| x-CDM330 AS | 125 | 4.6 | Quartz Shroud + Moly |
| | | | Coil + Thick Wall Bulb |
| x-CDM830W | 235 | 24.0 | 2x Quartz Shroud + 2x |
| | | | Moly Coils + End Caps in |
| | | | accordance with |
| | | | embodiments of the |
| | | | present system. |

For example, during a containment test such as the ANSI contaiment test, a lamp may be operated at 3-4 times its rated power for a period of about 5 seconds which may cause the arc tube to rupture. However, in accordance with the present system, lamps with two concentric quartz shrouds, each with a moly wire wrapped around it, and two end caps (e.g., shrouds) keeps parts from flying out the ends of the shroud, thus containing the ruptured tube in accordance with the containment test of present embodiments. Accordingly, lamps using containment methods in accordance with the present system may pass applicable containment tests. In accordance with embodiments of the present system, concentric quartz shrouds may each have a wall thicknes of 2 mm.

Referring back to FIGS. 15A and 15B, lamp efficacy of certain lamps of certain wattage may be reduced (e.g., from about 103 Im/W to 89 Im/W) by the shroud caps of the shroud portion 1530 and the added coils based upon their proximity to the light source such as the arc tube 1502. Accordingly, by increasing the lengh of the shrouds (e.g., from 100 mm to 150 mm), the lamp efficacy may be increased back to, for example, 100 Im/W. Accordingly, although some losses due to the use of the quartz shrouds, coils, and/or shroud caps may be unavoidable, an illumination efficacy of a lamp in accordance with embodiment of the present system may be controlled to provide in excess of about 90-100 Im/W.

Fill

Containment is only one aspect of CDM lamps in accordance with the present system. When lamps, such as CDM lamps, are new, they are subject to high re-ignition voltage spikes (hereinafter voltage spikes) that may cause the lamp to drop out (e.g., switch off) during the first minute of operation. This may be problemantic when using lighter gasses to fill an arc tube of the lamp. For example, the voltage spikes may be be higher when using Argon (Ar) rather than Krypton(Kr) or Xenon (Xe), and may be higher yet when using Neon (Ne) rather than Ar. The voltage spikes may be a result of hydrogen contamination and/or iodide contamination, and may be referred to as hydrogen iodide or HI voltage spikes (hereinafter both of which will be referred to as spikes) and are well known in the art. Minimizing spikes may be a matter of increasing the volume and pressure and is taught in U.S. Pat. No. 6,555,962, entitled Ceramic Metal Halide Lamp Having Medium Aspect Ratio, to Jackson et al., the contents of which are incorporated by reference herein. However, for lamps to start on the magnetic ballast without a high voltage pulse, the pressure within the lamp cannnot be too high and the product of electrode gap and pressure (P×D) should be minimized as is established by Paschen's law which is well known in the art. These two variables compete in that to reduce the breakdown voltage with a low pressure may also increase the HI spike voltages and cause a lamp to cycle out during runup. Accordingly, lamps in accordance with embodiments of the present system may use a fill as will be discussed below to overcome these limitations.

FIG. 18 is a graph which illustrates HI voltage spikes vs. Ne/Ar fill pressure for a lamp in accordance with the present system and FIG. 19 is a graph which illustrates starting time vs. electrode gap x fill pressure (P×D) for a lamp in accordance with embodiments of the present system. Referring to FIGS. 18 and 19, a fill gas mixture of 99.5% Ne and 0.5% Ar (e.g., a Penning mixture) with a fill pressure lessthan or equal to 100 torr, was was found meet the ANSI maximum voltage spikerequirements (e.g., see, FIG. 18) while simultainiously meeting the starting time requirements at 622 volts minimum open circuit voltage for the ANSI M47 magnetic 1000 watt QMH ballast (e.g., see, FIG. 19) when the electrode gap distance is, for example, set to 18 mm. However, other distances are also envisioned.

A voltage of a lamp in accordance with embodiments of the present system may be adjusted to give an average lamp operating power of 830 watts on most commercial CWA type ballasts. Thus, lamps in accordance with the present system may be an ideal retrofit lamp for conventional QMH lamps with higher power ratings (e.g., 1000 watts). Further, because there is little or no Na loss in ceramic lamps as compared to quartz lamps of the present system, ceramic lamps of the present system may exhibit superior lumen maintenance to conventional QMH lamps. As such, an initial lower luminous flux of a ceramic MH lamp as compared to a QMH lamp, may be offset over life by the better lumen performance as shown in FIG. 20 which is a graph which illustrates luminous flux vs. hours for a CDM lamp in accordance with the present system rated at 830 W and an equivalent QMH 1000 W lamp.

FIG. 21 is a graph which illustrates luminous efficacy vs. MnI₂ dose for fill of an arc tube of a lamp in accordance with embodiments of the present system. The fill may include salts suitable for ceramic lamps such as salts based on the iodides of Na, TI, Ca, Ce, and Mn, but may include other materials such as Dy, Tm, Ho, Li, In and/or others as may be known in the art. However, as illustrated in FIG. 21, a critical amount of Mn has been found and in certain embodiments, should not be exceeded or the luminous efficacy can be significantly reduced as illustrated in FIG. 21. For example, above about 2.7 mg of MnI₂, the efficacy is observed to be reduced by 10 to 15 Im/W. This may be due to, for example, self absorption. However, even if the critical amount of Mn is exceeded, blackenign of arc tubes in accordance with embodiments of the present system will be negligible or non-existent.

FIG. 22 is a graph which illustrates color temperature (CCT) vs. Cerium Iodide (CeI₃) dose for a fill of an arc tube of a lamp in accordance with embodiments of the present system; and FIG. 23 is a graph which illustrates mean perceptable color difference (MPCD) vs. CCT for experimental high wattage CDM for lamps in accordance with embodiments of the present system. With regard to color temperature, it has been observed that although it may be influenced by several factors, it may be primarly influcenced by the quantity of CeI₃ in arc tubes of lamps in accordance with embodiments of the present system, as illustrated in FIG. 22.

While it is may be desirable to operate the lamp at a color temperature of about 4000 K (e.g., a “4K” lamp), a range of CCT's between about 3500 K and 4400 K may also be considered “4K” lamps. It was found, that the selected CCT value, may have a strong corralation with a MPCD value which is a measure of how far above (e.g., represented as positive values) or below (e.g., represented as negitive values) the black body line the color coordinates are. It may be desirable to be in the range of ±15 points around zero. This means the CCT would be in the range of 3200 K to 3800 K as shown in FIG. 23. Therefore, in accordance with some embodiments of the present system, the CeI₃ dosed weight may be in the range of about 1.5 mg to 4.5 mg although as shown, other ranges may also be suitably applied.

FIG. 24 is a graph illustrating salt ranges of iodide salt doses for enhanced results for lamps in accordance with embodiments of the present system. Further, Table 2 below shows the ranges of the salts in weight percent that may yield enhanced results for lamps in accordance with embodiments of the present system. However, it is envisioned that other types and/or ranges of salt mixes may also be suitably applied.

TABLE 2
Salt ranges

| Iodide | Preferred Range |
|---|---|
| NaI | 0.8-3.8 wt % |
| TlI | 2.3-3.0 wt % |
| CaI2 | 82.6-93.8 wt % |
| CeI3 | 2.3-6.8 wt % |
| MnI2 | 0.8-3.8 wt % |

Table 3 below illustrates experimental test results for lamps (e.g., n=14 lamps) with an iodide salt variation within the design ranges shown in Table 2 above and containment structures in accordance with embodiments of the present system. For example, in accordance with embodiments of the present system, salts for these lamps may have a mixture of about Sodium Iodide (NaI)=1.0 wt %, Thallium Iodide (TiI)=2.6 wt %, Calcium Iodide (CaI2)=92.5 wt %, CeI3=2.6 wt %, and Manganese Iodide (MnI2)=1.3 wt %. However, other mixtures are also envisioned.

FIG. 25 is a table illustrating photometry results for the 14 lamps discussed above and whose experimental test results are illustrated in Table 3 below in accordance with embodiments of the present system. These lamps may correspond with, for example, an 830W or 830 Watt lamp (e.g., see, the CDM830W lamp in Table 1) and may include an arc tube, dual quartz shrouds (e.g., sleeves) with dual coils (or coils) and shroud caps (e.g., caps), a dual frame for support, and a quartz insulator to insulate electrical leads from opposite electrical potential. This lamp may include features and/or characteristics which may correspond with the lamp shown in FIGS. 16, 17.

TABLE 3
Experimental results

| n = 14 | Volts | Power | Lumens | Little x | Little y | CCT | CRI | MPCD | lm/W |
|---|---|---|---|---|---|---|---|---|---|
| Average | 227 | 830 | 82086 | 0.398 | 0.398 | 3722 | 95 | 15 | 99 |
| Std Dev | 10 | 0.4 | 1689 | 0.003 | 0.004 | 81 | 0.3 | 6.3 | 2 |

CIE color chromaticity coordinates.

In accordance with a manufacturing process for embodiments of the present system, during a first act, a coil may be wrapped around an inner shroud. Then, during a second act, the combination of the inner shroud and the coil may be inserted into outer shroud that has been pre-coiled, or coiled after insertion of the inner so as to form a double shroud assembly. Then, during a third act, components of the lamp may be placed in an assembly fixture for final assembly. Accordingly, the fame, the shrouds, the arc tube and arc tube connecting pieces, and the end caps may be placed in the assembly fixture in, for example, the order listed. However, other orders are also envisioned. During a fourth act, it is envisioned that parts which are held in place by the fixture assembly may be welded to each other so as to couple adjacent parts together. Then during a fifth act, the frame assembly may be removed from the assembly During a sixth act, parts such as getter, an outermost coil (if provided), a mica disk, and/or an upper dome spring may be attached to the frame using any suitable method such as welding, etc. Then, during a seventh act, a lamp assembly process may be performed to seal the frame and the parts attached thereto within an outer bulb which may include a mounting portion.

Accordingly, there is provided an energy saving CDM lamp which may be compatible with (e.g., starts and operates with) ballasts designed for other types of lamps such as a probe start QMH 1000W ballast (e.g., an ANSI code M47 ballast) and/or a pulse start QMH 1000W ballasts (e.g., an ANSI code M141 ballast), and may include a protected “O” rating to run in both open or enclosed fixtures. As such, lamps of the present system may be operative as retrofit lamps in conventional systems such as a QMH 1000 watt system and, when operated under nominal conditions, may run at 830W and provide a 17% savings in power over conventional 1000W QMH lamps. Further, CDM lamps of the present system may operate at other wattages such as lower and/or higher wattages than examples provided herein. For example, it is envisioned that lamps according to embodiments of the present system may be provided to retrofit conventional QMH 750, 875, 1250, 1500, 1650, and 2000W lamps. However, it is envisioned that lamps according to embodiments of the present system may be provided to retrofit other lamp types and/or power ratings are also envisioned.

Accordingly, the present system provides a high power ceramic discharge metal halide (CDM) lamp and a process, method and system which may be compatible with (e.g., may start and/or run) conventional ballasts such as a probe start magnetic ballast designed for 1000 watt quartz metal halide (QMH) lamps. The QMH lamp has a nominal voltage of 265 volts (compared to 135 volts for medium power lamps) and a power factor greater than 0.90. The present system provides a CDM lamp which may have a power factor of, for example, less than 0.85 and a voltage less than 240 volts, to operate at an energy saving power of 820-850 watts on QMH 1000 watt magnetic systems. Over the lifespan of a CDM lamp of the present system when compared with a conventional QMH counterpart such as a 1000 watt QMH bulb, the light output may start lower, but ends higher due to excellent lumen maintenance of the ceramic lamp and its 30% to 70% longer life. As a further benefit, a lamp in accordance with the present system can be used in open fixtures and may include an arc tube containment portion which can enhance the light output from an arc tube of the lamp.

Further variations of the present system would readily occur to a person of ordinary skill in the art and are encompassed by the following claims.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

The specification and drawings are to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) the term “plurality of” an element includes two or more of the claimed element, and does not imply any particular range of number of elements; that is, a plurality of elements may be as few as two elements, and may include an immeasurable number of elements.

What is claimed is:

1. A ceramic discharge metal halide (CDM) lamp, comprising:
a first shroud comprising a first wall forming a cylinder defining a first cavity;
a second shroud situated within the first cavity and comprising a second wall forming a cylinder defining a second cavity situated within the first cavity of the first shroud;
a first coil situated about at least one of the first and second shrouds; and
a ceramic arc tube situated in the second cavity and having first and second openings, first and second leads, and defining a lamp cavity for containing a fill.

2. The lamp of claim 1, further comprising a second coil situated between the first and second shrouds, wherein the first coil is situated about the first shroud.

3. The lamp of claim 1, further comprising a frame having first and second side members which extend on opposite sides of the first and second shrouds.

4. The lamp of claim 4, further comprising first and second shroud caps coupled to the side members of the frame and which locate the first and second shrouds relative to each other.

5. The lamp of claim 1, wherein the fill comprises a Penning mixture or a gas mixture of 99.5% Neon (Ne) and 0.5% Argon (Ar).

6. The lamp of claim 5, wherein the fill has a pressure less than or equal to 100 torr.

7. The lamp of claim 5, wherein the fill further comprises a salt mix having Iodides selected from Sodium Iodide (NaI), Thallium Iodide (TII), Calcium Iodide (CaI2), Cerium Iodide (CeI3), and Manganese Iodide (MnI2).

8. The lamp of claim 7, wherein percent weights of the Iodides of NaI, TII, CaI2, CeI3, and MnI2 range from between 0.8-3.8, 2.3-3.0, 82.6-93.8, 2.3-6.8, and 0.8-3.8, respectively.

9. A method for forming a ceramic discharge metal halide (CDM) lamp, the method comprising acts of:
forming a first shroud comprising a first wall forming a cylinder defining a first cavity;
forming a second shroud situated within the first cavity and comprising a second wall forming a cylinder defining a second cavity; situating a first coil around at least one of the first and second shrouds; and
placing a ceramic arc tube in the second cavity and having first and second openings, first and second leads, and defining a lamp cavity for containing a fill.

10. The method of claim 9, further comprising an act of situating a second coil between the first and second shrouds, wherein the first coil is situated about the first shroud.

11. The method of claim 9, further comprising an act of forming a frame having first and second side members which extend on opposite sides of the first and second shrouds.

12. The method of claim 11, further comprising an act of attaching first and second shroud caps to the side members of the frame to position the first and second shrouds relative to each other.

13. The method of claim 9, further comprising an act of filling the lamp cavity with the fill, wherein the fill comprises a Penning mixture or a gas mixture of 99.5% Neon (Ne) and 0.5% Argon (Ar).

14. The method of claim 9, further comprising an act of pressurizing the lamp cavity to have a pressure less than or equal to 100 torr.

15. The method of claim 9, further comprising an act of forming the fill to comprise a salt mix having Iodides selected from Sodium Iodide (NaI), Thallium Iodide (TII), Calcium (II) Iodide (CaI2), Cerium (III) Iodide (CeI3), and Manganese Iodide (MnI2) into the cavity.

16. The method of claim 15, further comprising an act of forming the fill such that the percent weights of the Iodides of NaI, TII, CaI2, CeI3, and MnI2 range from between 0.8-3.8, 2.3-3.0, 82.6-93.8, 2.3-6.8, and 0.8-3.8, respectively.

17. A ceramic discharge metal halide (CDM) lamp, comprising:
a first shroud comprising a first wall forming a cylinder defining a first cavity;
a second shroud situated within the first cavity and comprising a second wall forming a cylinder defining a second cavity situated within the first cavity of the first shroud;
a first coil situated between the first shroud and the second shroud; and
a ceramic arc tube situated in the second cavity and having first and second openings, first and second leads, and defining a lamp cavity for containing a fill.

18. The lamp of claim 17, further comprising a second coil situated around the first and second shrouds.
